(19) United States
(12) Patent Application Publication
(10) Pub. No.: US 2026/0042377 A1
(43) Pub. Date: Feb. 12, 2026

(54) STATE-OF-CHARGE-BASED VEHICULAR MICRO CLOUD TASK SCHEDULING

(71) Applicant: TOYOTA MOTOR ENGINEERING & MANUFACTURING NORTH AMERICA, INC., Plano, TX (US)

(72) Inventors: SEYHAN UCAR, Mountain View, CA (US); Chunghan LEE, Mountain View, CA (US); Emrah Akin SISBOT, Mountain View, CA (US); Onur ALTINTAS, Mountain View, CA (US); Kentaro OGUCHI, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, TOYOTA-SHI (JP)

(21) Appl. No.: 18/797,693

(22) Filed: Aug. 8, 2024

(51) Int. Cl. B60L 58/13; H04W 4/46

(52) U.S. Cl. CPC B60L 58/13; H04W 4/46

(57) ABSTRACT

Aspects of the presently disclosed technology may be implemented to provide systems and methods which integrate electric vehicles (EVs) into vehicular micro clouds (VMCs) by reducing the impact of VMC participation on the state-of-charge of integrated EVs. For example, an EV of the presently disclosed technology may join a first VMC comprising a group of connected vehicles that share resources to complete a task. The EV may predict that performance of one or more sub-tasks assigned to the EV by the first VMC will deplete a state-of-charge of the battery over a threshold amount. Based on the prediction, the EV may withhold performance of the one or more sub-tasks. The EV may then become leader of a second VMC, and as leader of the second VMC, assign the one or more sub-tasks to one or more vehicles of the second VMC.

### TECHNICAL FIELD

The present disclosure relates generally to automotive systems and technologies. More particularly, some embodiments relate to facilitating electric vehicle participation in vehicular micro clouds.

### DESCRIPTION OF RELATED ART

A vehicle may include sensors that collect data related to the operation of the vehicle and the vehicle's surrounding environment. Such data can be processed to provide information/recommendations that help a driver of the vehicle, other current or future road users, individuals interested in the development and usage of road infrastructure, etc. In some cases, processing sensor data to provide assisting information/recommendations can burden the (single) vehicle's processing resources.

Accordingly, vehicles and roadside infrastructure elements can collectively form a vehicular micro cloud (VMC). Members of the VMC can offer their respective resources (e.g., sensor resources, processing resources, memory resources, communication resources, etc.) to collaboratively perform a task (sometimes referred to herein as a VMC task). Examples of VMC tasks may include sensing tasks, computing tasks, storage tasks, communication tasks, etc. Members of the VMC can share information via different types of vehicle-to-everything (V2X) networks, such as vehicle-to-vehicle (V2V) networks. Output associated with VMC tasks (e.g., recommendations to make threat-mitigating actions such as changing a lane or altering a speed responsive to a detected threat) may be shared amongst VMC members. In various implementations, a VMC may comprise a leader that assigns sub-tasks (sometimes referred to herein as VMC sub-tasks) to members and distributes the collective output derived from the sub-tasks to VMC members.

### BRIEF SUMMARY OF THE DISCLOSURE

According to various embodiments of the disclosed technology, an electric vehicle (EV) is provided. The EV may comprise: (1) a battery that supplies electrical energy to an electric motor of the electric vehicle; (2) one or more processors; and (3) memory storing machine-readable instructions that, when executed by the one or more processors, cause the EV to: (a) join a first vehicular micro cloud (VMC) comprising a group of connected vehicles that share resources to complete a task; (b) predict an amount by which performance of one or more sub-tasks assigned to the EV by the first VMC will deplete a state-of-charge of the battery; and (c) based on the prediction indicating that the performance of the one or more sub-tasks will deplete the state-of-charge of the battery over a threshold amount: (i) withhold performance of the one or more sub-tasks; (ii) become leader of a second VMC; and (iii) as the leader of the second VMC, assign the one or more sub-tasks to one or more vehicles of the second VMC.

In certain embodiments of the EV, withholding performance of the one or more sub-tasks may comprise storing data related to the one or more sub-tasks in the memory. Relatedly, assigning the one or more sub-tasks to one or more vehicles of the second VMC may comprise transferring the data related to the one or more sub-tasks to the one or more vehicles of the second VMC. In some of these embodiments, the data related to the one or more sub-sub-tasks may comprise code blocks for performing the one or more sub-tasks.

In various embodiments of the EV, the machine-readable instructions, when executed by the one or more processors, may further cause the EV to transmit a notification to a leader of the first VMC after assigning the one or more sub-tasks to the one or more vehicle of the second VMC.

In some embodiments of the EV, the machine-readable instructions, when executed by the one or more processors, may further cause the EV to initiate formation of the second VMC.

In certain embodiments of the EV, predicting that performance of the one or more sub-tasks will deplete the state-of-charge of the battery over the threshold amount may comprise using a look-up table that maps predicted energy consumption to VMC sub-tasks.

In various embodiments of the EV, predicting that performance of the one or more sub-tasks will deplete the state-of-charge of the battery over the threshold amount may comprise using a machine learning model trained to predict energy consumption for VMC sub-tasks.

In some embodiments of the EV, predicting that performance of the one or more sub-tasks will deplete the state-of-charge of the battery over the threshold amount may comprise predicting that performance of the one or more sub-tasks will deplete the state-of-charge of the battery such that the EV will not reach a target destination without further charging the battery.

In certain embodiments of the EV, the one or more sub-tasks may comprise post-processing sub-tasks. In various of such embodiments, the post-processing sub-tasks may comprise refining an analytical model and uploading the refined analytical model to a remote server.

In various embodiments of the EV, the second VMC may comprise a second group of connected vehicles. Here, other than the EV, the second group of connected vehicles may comprise different vehicles than the group of connected vehicles.

In certain embodiments, a method is provided. The method may comprise: (1) joining, by an electric vehicle (EV), a first vehicular micro cloud (VMC) comprising a first group of connected vehicles that share resources to complete a task; (2) predicting, by the EV, that performance of one or more sub-tasks assigned to the EV by the first VMC will deplete a state-of-charge of the EV over a threshold amount; and (3) based on the prediction indicating that the performance of the one or more sub-tasks will deplete the state-of-charge of the battery over a threshold amount: (i) withholding, by the EV, performance of the one or more sub-tasks based on the prediction; (ii) becoming, by the EV, leader of a second VMC; and (iii) assigning, by the EV as the leader of the second VMC, the one or more sub-tasks to one or more vehicles of the second VMC.

In some embodiments of the method, withholding performance of the one or more sub-tasks may comprise storing data related to the one or more sub-tasks in memory. Relatedly, assigning the one or more sub-tasks to one or more vehicles of the second VMC may comprise transferring the data related to the one or more sub-tasks to the one or more vehicles of the second VMC. In certain of such embodiments, the data related to the one or more sub-tasks may comprise code blocks for performing the one or more sub-tasks.

In various embodiments of the method, the method may further comprise transmitting a notification to a leader of the first VMC after assigning the one or more sub-tasks to the one or more vehicle of the second VMC.

In some embodiments, the method may further comprise initiating formation of the second VMC.

In certain embodiments of the method, predicting that performance of the one or more sub-tasks will deplete the state-of-charge of the EV over the threshold amount may comprise at least one of: (a) using a look-up table that maps predicted energy consumption to VMC sub-tasks; and (b) using a machine learning model trained to predict energy consumption for VMC sub-tasks.

In various embodiments of the method, the one or more sub-tasks may comprise post-processing sub-tasks. In some of such embodiments, the post-processing sub-tasks may comprise refining an analytical model and uploading the refined analytical model to a remote server.

In some embodiments, a second method is provided. The second method may comprise: (1) forming a first vehicular micro cloud (VMC) comprising an electric vehicle (EV); (2) identifying one or more sub-tasks of the first VMC that are deferrable for greater than a pre-determined amount of time; (3) assigning the one or more deferrable sub-tasks to the EV; (4) predicting that performance of the one or more deferrable sub-tasks by the EV will deplete a state-of-charge of the EV over a threshold amount; (5) forming a second VMC with the EV as leader of the second VMC; and (6) causing the EV to assign the one or more deferrable sub-tasks to one or more other vehicles of the second VMC.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIGS. 1A-1B illustrate an example formation of a vehicular micro cloud (VMC) that includes an electric vehicle (EV), in accordance with various embodiments of the presently disclosed technology.

FIG. 2 illustrates an example EV, in accordance with various embodiments of the presently disclosed technology

FIG. 3 illustrates an example implementation of a VMC management system, in accordance with various embodiments of the presently disclosed technology.

FIG. 4 illustrates an example process that may be performed by an EV to participate in VMCs, in accordance with various embodiments of the presently disclosed technology.

FIGS. 5A-5B illustrate example VMCs described in conjunction with FIG. 4.

FIG. 6 illustrates an example process that can be performed by a VMC management system to facilitate EV participation in VMCs, in accordance with various embodiments of the presently disclosed technology.

FIG. 7 is an example computing component that may be used to implement various features of embodiments described in the present disclosure.

The figures are not exhaustive and do not limit the present disclosure to the precise form disclosed.

### DETAILED DESCRIPTION

Systems and methods associated with improving vehicular micro cloud (VMC) operation are disclosed herein. As described above, a VMC may refer to a network of connected vehicles that cooperate to complete a task (or tasks) by sharing resources (e.g., sensor resources, processing resources, memory resources, communication resources, etc.).

For example, navigation of a road segment can be dangerous due to various roadway conditions. Such roadway conditions may include road surface conditions on the road segment (e.g., wet or icy road surface conditions), objects on the road segment, behavior of vehicles on the road segment, etc. Vehicle perception systems may enhance driver safety by relaying data about detected roadway conditions. However, the perception system of a single vehicle may be limited in its ability to capture data associated with such roadway conditions. Accordingly, a VMC may be formed to provide assistance by expanding a region about which roadway condition data may be collected. The aggregated resources of the VMC may be used for other purposes as well. For example, the aggregated VMC resources may be used to provide a more comprehensive perception of roadway conditions on a road segment. As another example, the aggregated resources of the VMC can be used to provide additional storage and processing resources so that more complex tasks can be performed more quickly. Outputs from such tasks (e.g., recommendations to take threat-mitigating actions such as changing a lane or altering a speed responsive to a detected threat) can improve safety and traffic efficiency for members of the VMC and other vehicles on a road segment.

However, completion of VMC tasks/sub-tasks can consume significant electrical energy, which can be problematic for electric vehicles (EVs).

An EV may refer to a vehicle that is powered (at least in part) by an electric motor (sometimes referred to herein as a motor generator) for propulsion. Examples of EVs may include battery electric vehicles (BEVs) or other types of EVs such as a plug-in hybrid electric vehicle (PHEVs).

In some cases, performing a VMC sub-task may reduce the state-of-charge of an EV (or more particularly, a state-of-charge of a battery in the EV) to a point where the EV cannot reach a target destination that it otherwise could. In other cases, performing the VMC sub-task may more generally change the reported state-of-charge by a degree that negatively impacts operation of the EV or a consumer's experience with EV technology. For example, upon entering an EV, the EV may indicate to the driver that the battery has a state-of-charge of 25% (i.e., 25% of full capacity). A driver may rely on this indicated state-of-charge when deciding whether they can reach a target destination. As the EV travels, the EV may join a VMC and be asked to execute a particular sub-task, which may consume energy and result in a drop to a state-of-charge of 5%. Accordingly, the driver who relied on the previously-reported state-of-charge level to reach their target destination may no longer be able to reach the target destination due to the unexpected reduction in state-of-charge.

In some cases, the driver may still be able to reach their target destination, but with a lower state-of-charge than originally predicted. For example, when driving home from work, a driver may, with time, determine that their state-of-charge changes 15% for this itinerary. Accordingly, on a particular day when the driver leaves work and sees a state-of-charge of 25%, they may be confident that they will reach home. However, if the EV executes VMC sub-task(s) on the driver's journey home, the driver may notice the EV's reported state-of-charge at home to be 5% (i.e., a consumption of 20% of battery power rather than the expected 15%). Accordingly, the driver may lose confidence in the EV's state-of-charge reporting, which could lead to reduced use of the EV or replacement of the EV with a non-electric vehicle. In a more extreme example, the driver might not be able to reach their intended destination due to the higher rate of consumption. In summary, for any EV, a reported range of the EV is particularly relevant as a driver relies on this prediction to determine how far they can/should travel. Any calculation error or change to the predicted/expected range may reduce the confidence that drivers have in EVs. In other words, discrepancies in energy consumption/energy availability may negatively impact the performance of EVs and negatively bias drivers of the EVs.

Moreover, based on the reduction of battery state-of-charge caused by performing VMC sub-tasks, EV drivers may elect not to join a VMC due to a perceived incompatibility of EVs and the VMC. As VMC utility and efficacy can depend on the number of members in an VMC, discouraging EV involvement in a VMC may reduce the efficacy and utility of VMCs to all member vehicles and the VMC environment in general.

Against this backdrop, aspects of the presently disclosed technology may be implemented to provide systems and methods which integrate EVs into VMCs by reducing the impact of VMC participation on the state-of-charge of integrated EVs.

For example, a first VMC may be formed that includes an EV as a member. Detecting that the EV is a member of the first VMC, a leader of the first VMC may identify one or more sub-tasks of the first VMC that can be performed at a later time (e.g., post-processing sub-tasks such as refining an analytical model and uploading the refined analytical model to a remote server). In other words, the leader of the first VMC may identify one or more sub-tasks of the first VMC that are deferrable for over a pre-determined amount of time. The leader of the VMC may then assign the deferrable sub-task(s) to the EV.

Upon being assigned the deferrable sub-task(s), the EV may predict that performance of the deferrable sub-task(s) will deplete a state-of-charge of the EV over a threshold amount. In various implementations, this may comprise predicting that performance of the deferrable sub-task(s) will deplete the state-of-charge of the EV such that the EV will not reach a target destination without further charging.

Based on this prediction, the EV may withhold/defer performance of the deferrable sub-task(s). In some implementations, this may involve storing data (e.g., code blocks for executing the deferrable sub-task(s)) related to the deferrable sub-task(s) in memory.

To ensure (and in some cases expedite) completion of the deferrable sub-task(s), the EV may initiate formation, and become leader of, a second VMC. As leader of the second VMC, the EV may then assign the deferrable sub-task(s) to vehicles of the second VMC. In some implementations, this may comprise transmitting stored data related to the deferrable sub-task(s) to the vehicles in the second VMC.

In various implementations, the EV and members of the second VMC may receive an output of the first VMC group (e.g., a recommendation/instructions to avoid a recklessly driven vehicle on a road segment) due to their contribution. Relatedly, in certain implementations the EV or the members of the second VMC may report to the leader of the first VMC that the deferrable sub-task(s) have been completed.

As may be appreciated, the EV can contribute to the first VMC by storing data related to the deferrable sub-task(s) in memory and later assigning the deferrable sub-task(s) to other vehicles for completion. In implementations where the second VMC comprises a different group of vehicles than the first VMC (e.g., when the EV traverses a road segment such that it is surrounded by the different group of vehicles), this may facilitate a wider distribution of sub-tasks of the first VMC (i.e., a distribution of sub-tasks across a larger number of vehicles). Here, a wider distribution of VMC sub-tasks can facilitate a reduced per-vehicle resource load among contributing vehicles. Moreover, by storing and then transmitting data associated with the deferrable sub-task(s) to other vehicles, the EV may consume significantly less power than would be the case if the EV were to perform the deferrable sub-task(s) itself. Accordingly, the EV may better conserve its state-of-charge along its journey. Additionally, by assigning the deferrable sub-task(s) to other vehicles in the second VMC, the EV can facilitate (or at least increase the likelihood of) faster completion of the deferrable sub-task(s) than would be the case if the EV waited to perform the deferrable sub-task(s) while charging.

In this way, the disclosed systems and methods improve VMC operation. Specifically, embodiments facilitate the inclusion of EVs in a VMC. Such inclusion: (1) enhances the functionality of the VMC; (2) distributes VMC sub-tasks amongst more vehicles, thus reducing the per-vehicle resource load for VMC members, and (3) reduces the range/state-of-charge-altering impact of VMC participation by an EV.

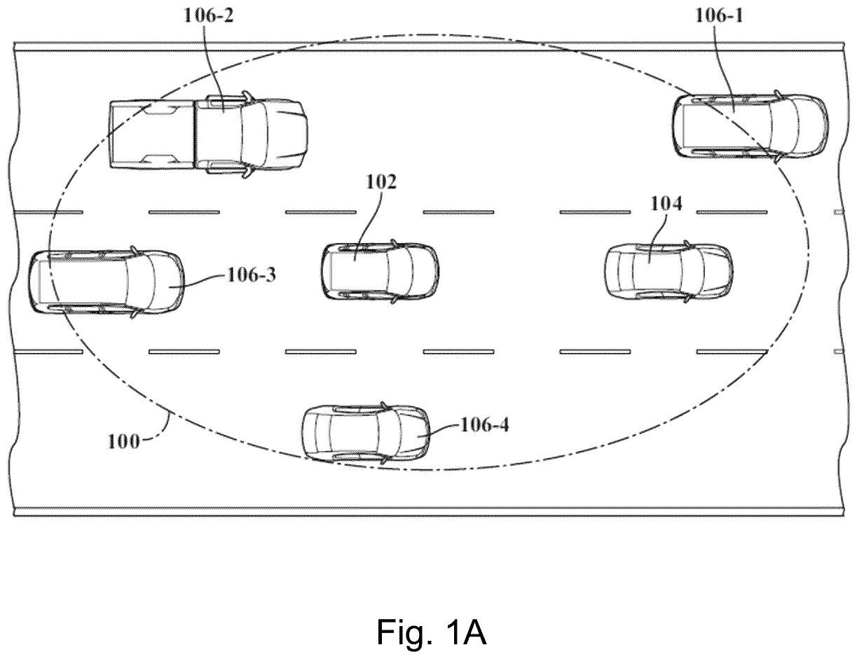

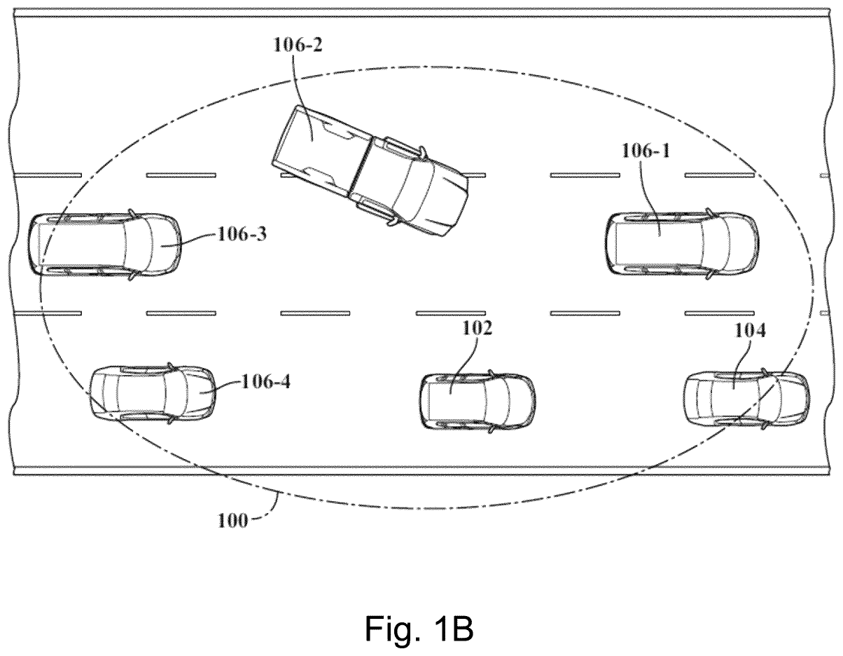

Turning now to the figures, FIGS. 1A and 1B illustrate an example formation of a VMC 100 that includes an EV 102. As described above, an EV may refer to a vehicle that is powered (at least in part) by an electric motor for propulsion. Examples of EVs may include battery electric vehicles (BEVs) or other types of EVs such as a plug-in hybrid electric vehicle (PHEVs). A relevant operational consideration for EVs (e.g., EV 102) is their range, or the distance that an EV can travel given a current battery state-of-charge. That is, over time, the capacity of a battery drops, and the distance an EV can travel is limited. A driver may make driving decisions based on EV state-of-charge.

For example, EV 102 may indicate to a driver of EV 102 a battery state-of-charge or a distance range of EV 102. In this example, the driver may decide not to travel to a particular destination because the destination may be beyond the reach of EV 102, given the current state-of-charge or distance range. By comparison, the driver may decide to complete the journey if the battery state-of-charge or distance range estimated by EV 102 is greater than the distance to be traveled.

FIGS. 1A and 1B also depict a VMC 100. As described above, a VMC may refer to a group of vehicles that share resources (e.g., sensor resources, processing resources, memory resources, communication resources, etc.) to complete a task.

As depicted, VMC 100 may include a leader 104. Leader 104 may be a vehicle (or in some cases a piece of roadside infrastructure or more generally a remote server) that manages operation of VMC 100. For example, leader 104 may receive a request for a task to be completed, assign sub-tasks to particular VMC members, receive the output/results of completed sub-tasks, aggregate/combine the output/results of the completed sub-tasks into an output/results of the overall task, and promulgate the output/results of the overall task to VMC members. In the context of the present application, leader 104 may, in some examples, assign sub-tasks to VMC members based on detecting EV 102 is part of VMC 100. For example, leader 104 may identify certain VMC sub-tasks (e.g., post-processing sub-tasks such as refining an analytical model, providing the refined analytical model to a remote server, etc.) that can be performed at a later time. In other words, leader 104 can identify one or more sub-tasks that are deferrable for over a pre-determined time period. Leader 104 may then assign one or more of the deferrable sub-tasks to EV 102. By contrast, leader 104 can assign undeferrable sub-tasks (i.e., those sub-tasks which are more time-sensitive) to non-EV vehicles in VMC 100.

Referring again to FIGS. 1A-1B, as depicted, VMC 100 may include leader 104, EV 102 and vehicles 106-1, 106-2, 106-3, and 106-4. Leader 104 and vehicles 106-1, 106-2, 106-3, and 106-may or may not be EVs.

As described above, through VMC 100, leader 104, EV 102, and vehicles 106-1, 106-2, 106-3, and 106-4 can share resources. Examples of shared resources may include sensor resources, processing resources, memory resources, communication resources, network bandwidth resources, etc. Examples of VMC sub-tasks that may be completed by a vehicle in VMC 100 may include executing software, executing calculations, sending/receiving messages, finding digital data stored by any member of VMC 100, instructing different members of VMC 100 to help with calculations, etc. Examples of information shared within VMC 100 may include image frames or video feeds from image sensors, image processing results, object detection results from proximity sensors, GPS coordinates, computation results from subsystems processing data from sensor sets, etc.

While particular reference is made to particular sub-tasks, various other sub-tasks may be completed by the members of VMC 100. When the various members complete these sub-tasks, leader 104 can provide a resultant/combined output of the sub-tasks to the members of VMC 100. That is, leader 104 (or in some cases a remote server) can aggregate data/output from the members to provide collaborative results relevant to a requested (overall) VMC task. Examples of tasks completed by VMC 100 may include dynamic map generation, cooperative path planning, distributed data storage, etc.

In some implementations, the members of VMC 100 may communicate using a vehicle-to-everything (V2X) network that enables vehicles to wirelessly communicate via one or more communication protocols. Examples of V2X networks may include Dedicated Short Range Communication (DSRC) networks (including Basic Safety Messages (BSMs) and Personal Safety Messages (PSMs), among other types of DSRC communication); Bluetooth® networks; Long-Term Evolution (LTE) networks; millimeter wave (mmWave) communication networks; 3G networks; 4G networks; 5G networks; LTE-V2X networks; 5G-V2X networks; LTE-Vehicle-to-Vehicle (LTE-V2V) networks; LTE-Vehicle-to-Infrastructure (LTE-V2I) networks, LTE-Vehicle-to-Network (LTE-V2N) networks, LTE-Device-to-Device (LTE-D2D) networks; Voice over LTE (VoLTE) networks; etc. In some examples, the V2X communications can include V2V communications, Vehicle-to-Infrastructure (V2I) communications, Vehicle-to-Network (V2N) communications, or any combination thereof. While particular reference is made to particular communication modalities of VMC 100, the communication network may include other connected paths across which multiple vehicles may communicate including other cellular or mobile communications networks. In other implementations, VMC 100 may comprise a network other than a V2X network. For example, certain V2X networks may not allow members to access and use the unused computing resources of the other endpoints of such networks. By comparison, VMC 100 may allow all members to access and use designated unused computing resources of the other members of VMC 100.

In various implementations, a respective member of VMC 100 can join VMC 100 via a handshake process with a coordinator of VMC 100 (e.g., leader 104 or a remote server). In certain implementations, the memory of a respective member can store member data. The member data may comprise digital data that describes one or more of the following: the identity of each of the members; what digital data, or bits of data, are stored by each member; what computing services are available from each member; what computing resources are available from each member and what quantity of these resources are available; and how to communicate with each member. In some implementations, the member data may also describe logical associations between vehicles.

VMC 100 may comprise various types of VMCs.

For example, VMC 100 may comprise a stationary VMC that is tied to a fixed geographical region (e.g., an intersection). A vehicle can join a stationary VMC and contribute its resources upon entering the fixed geographical region as determined by a GPS sensor of the vehicle. The vehicle may leave the stationary VMC upon exiting from the fixed geographical region. When exiting from the fixed geographical region, the vehicle may hand over ongoing sub-tasks and data of the stationary VMC to other members.

As another example, VMC 100 may comprise a mobile VMC. A mobile VMC may be formed around a particular vehicle (e.g., leader 104). Vehicles within a threshold distance of the particular vehicle can join the mobile VMC via a handshake operation. As the particular vehicle moves, the geographic location of the mobile VMC may change with the movement of the particular vehicle and other members of the mobile VMC. A vehicle can join the mobile VMC when the vehicle is in an area covered by the mobile VMC. The vehicle can leave the mobile VMC when the vehicle exits the area covered by the mobile VMC. Where VMC 100 is a mobile VMC, leader 104 may advertise VMC 100, and vehicles within a threshold distance of leader 104 may join/participate in VMC 100.

As another example, VMC 100 may comprise one of consecutive interdependent VMCs formed along a highway. For example, it may be the case that one mobile VMC is not sufficient to carry out a VMC task, such as defining a model of the behavior of vehicles on a particular stretch of the highway. Accordingly, as leader 104 travels along the highway, it may pass through different VMCs, and the different VMCs can perform different sub-tasks such that the output of the different VMCs may be used to generate a larger output that spans multiple regions associated with the individual VMCs.

In yet another example, VMC 100 may comprise a remote VMC where an ego vehicle can be connected to other vehicles that are remote from the ego vehicle. In this example, the ego vehicle may be a remote leader and remotely control the collaboration of members. For example, an ego vehicle in one city may want to know the parking availability in a city spaced apart from the city where the ego vehicle is located. In this example, the ego vehicle could form a remote VMC with vehicles in the target city. The vehicles in the target city, using exterior sensors, could indicate parking availability to the ego vehicle.

While particular types of VMCs are described herein, different types of VMCs 100 may be implemented in accordance with the principles described herein.

As described above, VMC 100 may include leader 104 that initiates formation of VMC 100 and otherwise manages VMC 100. In the context of the present specification, leader 104 may identify those sub-tasks that are completable at a later time (e.g., post-processing sub-tasks). In other words, leader 104 may identify those sub-tasks that are deferrable for over a pre-determined amount of time, and assign the deferrable sub-task(s) to EV 102. By contrast, leader 104 may assign undeferrable sub-tasks (i.e., more time-sensitive sub-tasks) to non-EV vehicles of VMC 100.

For example, the driver of a particular vehicle may want to know the conditions of a road section along which the particular vehicle is travelling. In this example, the particular vehicle may initiate the formation of VMC 100 (thus becoming leader 104) and broadcast formation of VMC 100 via a local communication network (e.g., a V2V communication network). Vehicles near the broadcast may join VMC 100 and connect to leader 104, thus becoming VMC members. In some cases, vehicles can opt-out of joining VMC 100 as well.

In a more detailed example, the particular vehicle (which may ultimately become leader 104) may send a request to a server such as an edge server or remote server. The request may include formation rules identifying a VMC task to be completed and a target geographic region and/or location for VMC 100. In response, the server may select a geographic region based on the target geographic region and set the particular vehicle as leader 104. The server and/or leader 104 may identify vehicles within the target region, for example, based on GPS coordinates of the vehicles.

Each vehicle within the identified target region may receive an invitation to join VMC 100, for example, through communication with a remote server or leader 104. An invitation to join VMC 100 may indicate a collaborative task for which the VMC 100 is formed and, in some examples, an indication of sub-tasks to be completed. Leader 104 and/or the remote server can then form VMC 100, for example, via a V2V handshake operation.

As described above, VMC 100 may be used for various tasks. FIG. 1B depicts one such task. It may be the case that a particular driver on the road operates their vehicle erratically in a way that poses a risk to adjacent vehicles. In this example, it may be desirable to advise certain vehicles to change their speed and/or change lanes to increase the distance between themselves and the erratically-operated vehicle. For example, it may be determined that a vehicle 106-2 is exhibiting a pattern of drifting over lane lines and dangerously speeding over a posted speed limit. In this example, some vehicles in VMC 100 may benefit from the enhanced perception of vehicle 106-2 by other vehicles in VMC 100. For example, vehicle 106-4 may be unable to detect the behavior of vehicle 106-2 due to the distance between vehicle 106-2 and vehicle 106-4 and the blocking of vehicle 106-4's sensors by EV 102. Accordingly, in this example, leader 104 may pool the environmental sensor output of multiple vehicles in VMC 100, including EV 102. Leader 104 may also assign various sub-tasks to the vehicles of VMC 100 to process the aggregated sensor data. The combined output of these sub-tasks may then be used to generate a risk analysis and/or recommended navigational guidance for vehicle 106-4 and other vehicles in VMC 100.

As another example, a vehicle in a first location (e.g., Detroit) may desire to know the parking conditions in a particular parking lot in another location (e.g., Ann Arbor). In this example, the vehicle in the first location may form VMC 100 with vehicles in the parking lot in the second location to ascertain parking availability. While particular reference is made to particular tasks for VMC 100, VMC 100 may be formed to complete various tasks.

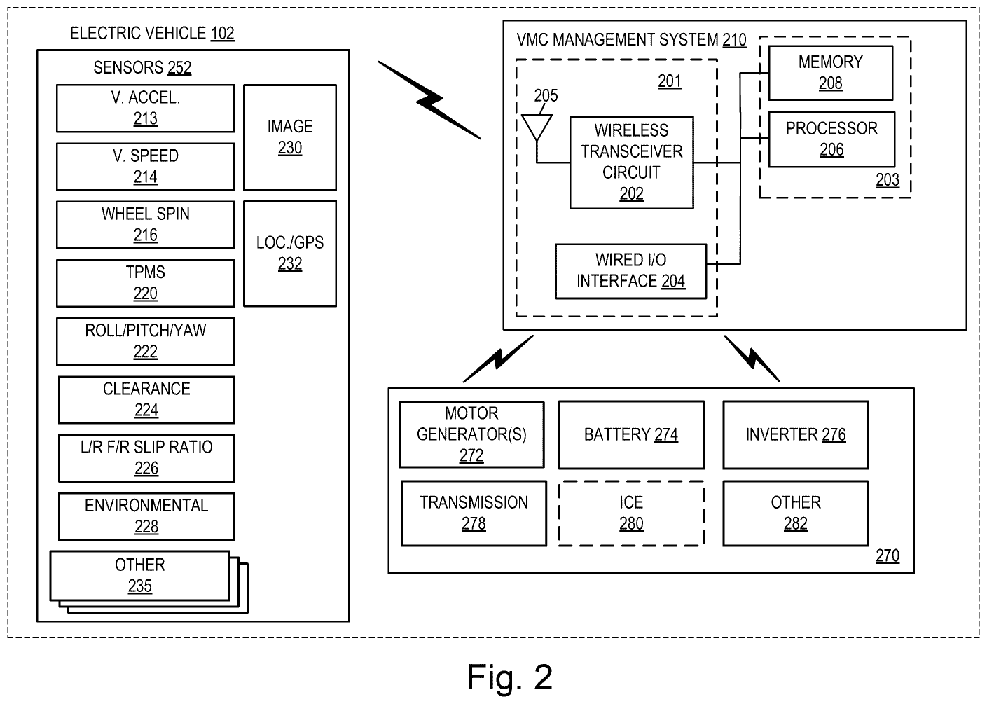

FIG. 2 illustrates electric vehicle (EV) 102 from FIGS. 1A-1B in more detail, in accordance with various embodiments of the presently disclosed technology.

As depicted, EV 102 comprises a VMC management system 210, sensors 252, and additional vehicle systems 270. Sensors 252 and additional vehicle systems 270 can communicate with VMC management system 210 via a wired or wireless communication interface. Although sensors 252 and additional vehicle systems 270 are depicted as communicating with VMC management system 210, they can also communicate with each other. VMC management system 210 can be implemented as an electronic control unit (ECU) or as part of an ECU. In other embodiments, VMC management system 210 can be implemented independently of an ECU.

In the specific example of FIG. 2, VMC management system 210 includes a communication circuit 201 and a decision circuit 203 (including a processor 206 and a memory 208). Components of VMC management system 210 are illustrated as communicating with each other via a data bus, although other interfaces can be included.

Processor 206 can include one or more general processing units (GPUs), central processing units (CPUs), microprocessors, or any other suitable processing system. Processor 206 may include a single core processor or multicore processors. Memory 208 can be made up of one or more modules of one or more different types of memory (e.g., flash, RAM, etc.) that may be used to store data related to VMC sub-tasks, look-up tables or other mappings which map predicted power consumption to VMC sub-tasks, weights and other parameters of machine learning models trained to predict power consumption for VMC sub-tasks, instructions and variables for processor 206, as well as any other suitable information.

Although the example of FIG. 2 is illustrated using processor and memory circuitry, in various embodiments decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up VMC management system 210.

Communication circuit 201 can utilize a wireless transceiver circuit 202 with an associated antenna 205 for wireless communication. Communication circuit 201 can also utilize a wired I/O interface 204 with an associated hardwired data port (not illustrated). As this example illustrates, communications with VMC management system 210 can include either or both wired and wireless communications. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment and to receive radio signals as well. These radio signals can include information of almost any sort that is sent or received by VMC management system 210 to/from other entities such as sensors 252, additional vehicle systems 270, other connected vehicles, connected roadside infrastructure, cloud computing entities, remote servers, etc.

Wired I/O interface 204 can include a transmitter and a receiver (not shown) for hardwired communications with other devices. For example, wired I/O interface 204 can provide a hardwired interface to other components, including sensors 252 and additional vehicle systems 270. Wired I/O interface 204 can communicate with other devices using Ethernet or any of a number of other wired communication protocols whether standardized, proprietary, open, point-to-point, networked or otherwise.

In certain implementations, decision circuit 203 and communication circuit 201 may be used for computation, memory, or communication tasks beyond VMC management. In other implementations, EV 102 may comprise additional processing, memory, or communication resources (not depicted) devoted to these other tasks.

Sensors 252 can include, for example, vehicle acceleration sensors 213, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, environmental sensors 1228 (e.g., to detect salinity or other environmental conditions), image sensor(s) 230, and location sensor(s) 232. Other sensors 235 can also be included as may be appropriate for a given implementation of EV 102. For example, other sensors 235 may include proximity sensors such as radar sensors, LiDAR sensors, and sonar sensors, etc. Other sensors 235 may also comprise sensors for detecting a state-of-charge for EV 102, such as sensors that detect a state-of-charge of battery system 274 (described below).

In some embodiments, image sensor(s) 230 may comprise one or more cameras (e.g., monocular cameras, stereoscopic cameras, RGB cameras, infrared cameras, etc.) configured to obtain image data of an environment surrounding EV 102.

In certain embodiments, location sensor(s) 232 may comprise a global navigation satellite sensor, a global position sensor, or other types of vehicle positioning sensors. Location sensor(s) 232 may be configured to generate location data for EV 102 and/or location data for landmarks in the environment surrounding EV 102. The location data may comprise precise coordinates (e.g., latitude, longitude, and altitude) of EV 102's position or the position(s) of landmark(s) on the Earth's surface.

In some embodiments, one or more of sensors 252 may include their own processing capability to compute the results for additional information that can be provided to VMC management system 210. In other embodiments, one or more of sensors 252 may be data-gathering-only sensors that only provide raw data to VMC management system 210. In further embodiments, one or more hybrid sensors may be included that provide a combination of raw data and processed data to VMC management system 210. Sensors 252 may provide analog outputs, digital outputs, or a combination of both.

Additional vehicle systems 270 can include any of a number of different vehicle components or subsystems used to control or monitor various aspects of EV 102 and its performance. For example, additional vehicle systems 270 may include any one or combination of a motor generator system 272, a battery system 274, an inverter 276, and a transmission 278. In implementations where EV 102 is a hybrid vehicle, additional vehicle systems 270 may further comprise an internal combustion engine (ICE) 280. Additional vehicle systems 270 may also comprise other vehicle systems 282.

Battery system 274 may deliver electrical power to motor generator system 272. Battery system 274 may also deliver electrical power to other components of EV 102, such as VMC management circuit 210, and other processing/memory resources of EV 102. Battery system 274 can include one or more batteries including, e.g., Li-ion batteries, Li-Polymer batteries, NiMH batteries, NiCd batteries, NiZn batteries, NiH2 batteries, etc. As alluded to above, in certain implementations battery 274 may be rechargeable. In some implementations, battery system 274 may also (or alternatively) comprise one or more energy harvesters (e.g., solar cells, piezoelectric system, etc.) or other suitable electrical power supplies. As described above, EV 102 may comprise one or more sensors that monitor operation of battery system 274, including monitoring a state-of-charge of battery system 274.

Motor generator system 272 may comprise one or more electric motors which output torque (either directly or indirectly) to wheels of EV 102. For example, in various implementations motor generator system 272 may output torque to transmission 278. In turn, transmission 278 can deliver torque to wheels of EV 102 based on the output torque of motor generator system 272. In certain implementations, motor generator system 272 can recharge battery system 274 as well.

In implementations where EV 102 is a hybrid vehicle, ICE 280 may deliver output torque to transmission 278 as well. In such implementations, ICE 280 and motor generator system 272 may be coupled through a planetary gear (not depicted). ICE 280 can be an engine that combusts fuel, such as gasoline, ethanol, diesel, biofuel, or other types of fuels which are suitable for combustion.

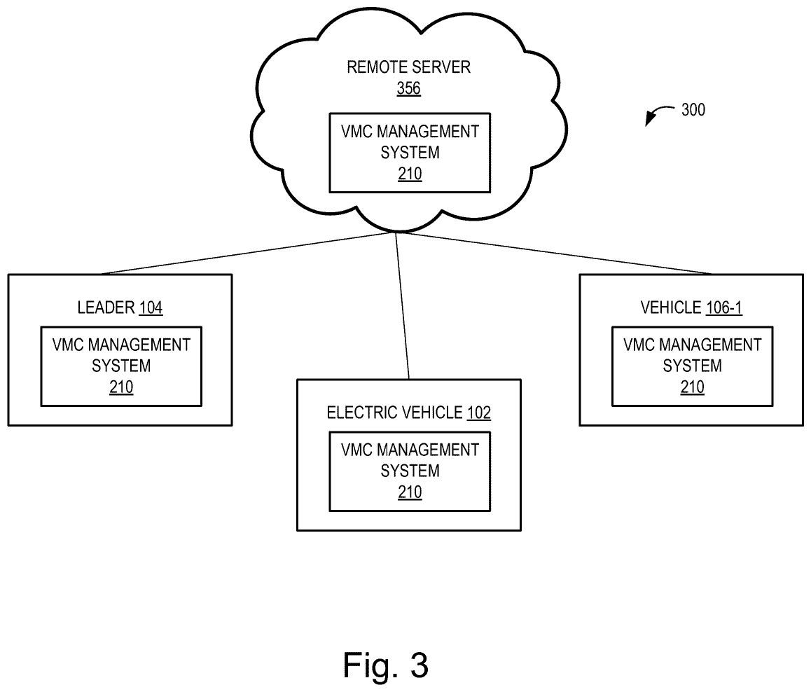

FIG. 3 depicts an example implementation of VMC system 210 from FIG. 2, in accordance with various embodiments of the presently disclosed technology.

As depicted in FIG. 3, in some embodiments VMC management system 210 may be implemented across a remote server 356 and members of a VMC (e.g., leader 104 and vehicle 106-1 from FIGS. 1A-1B, and EV 102 from FIGS. 1A-1B and FIG. 2). Such embodiments may be facilitated by a cloud-based environment 300.

Accordingly, as shown, VMC management system 210 may include separate instances within one or more entities of cloud-based environment 300, such as remote server 356 and members of a VMC. In a further aspect, the entities that implement VMC management system 210 within cloud-based environment 300 may vary beyond transportation-related devices and encompass roadside infrastructure elements, and thereby can function in cooperation with EV 102. Thus, the set of entities that function in coordination with cloud-based environment 300 may be varied.

Cloud-based environment 300 itself, may comprise a dynamic environment that comprises cloud members that migrate into and out of a geographic area.

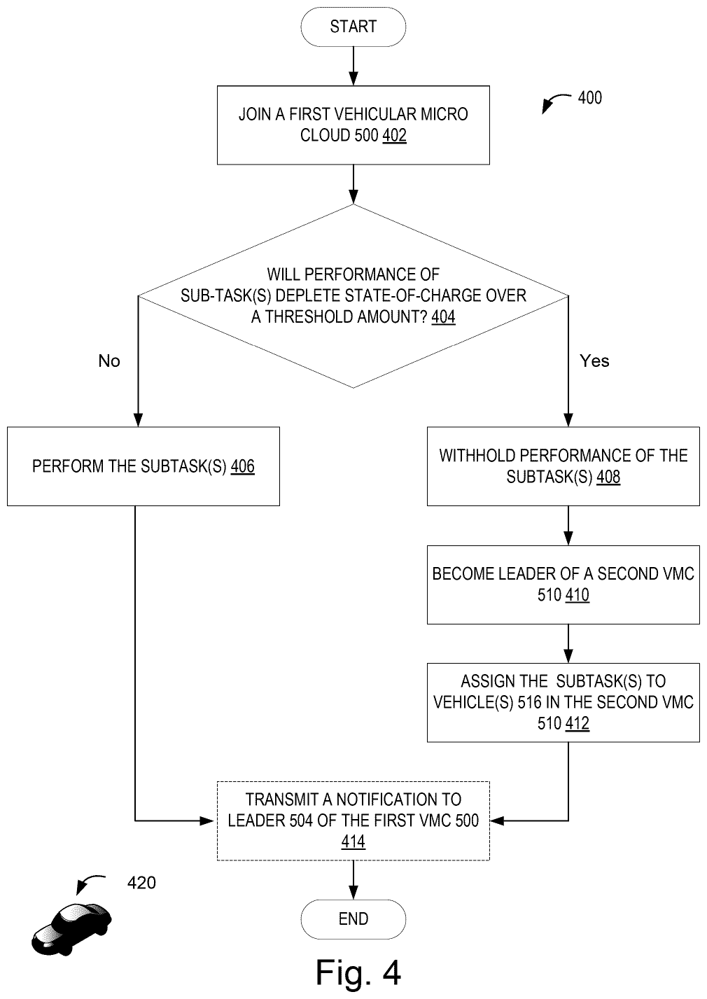

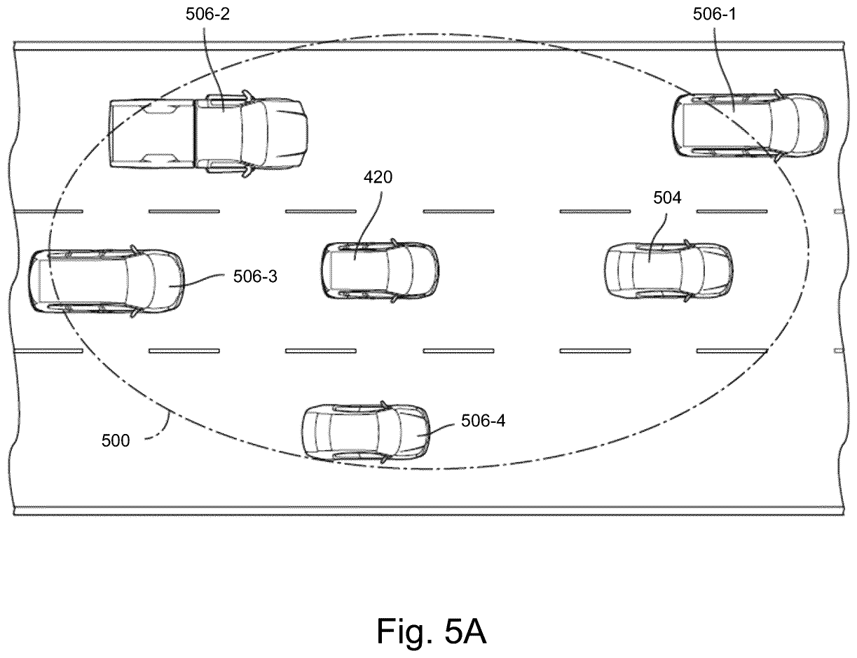

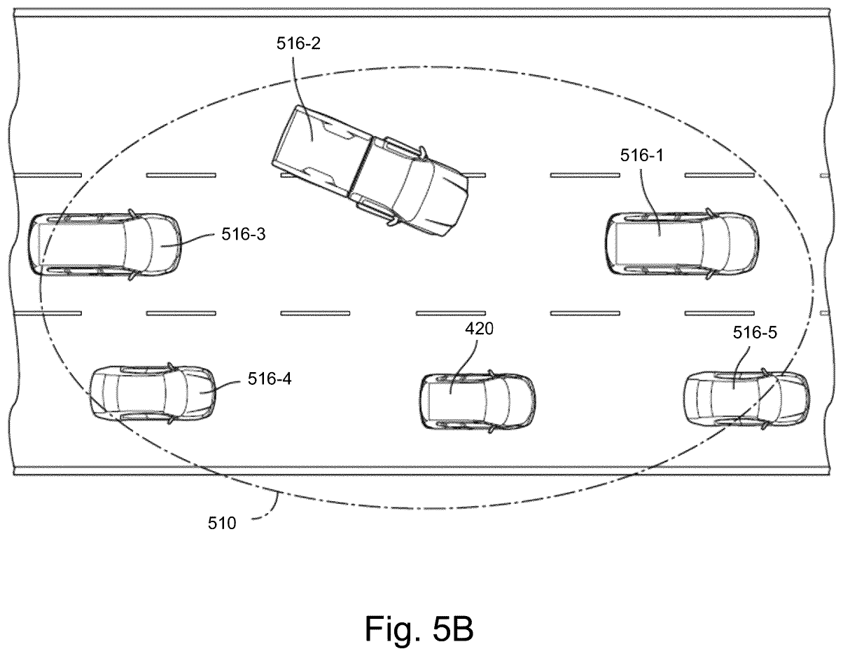

FIG. 4 depicts an example process 400 that may be performed by an EV 420 to participate in VMCs, in accordance with various embodiments of the presently disclosed technology. As companion figures to FIG. 4, FIGS. 5A and 5B depict a first VMC 500 and a second VMC 510 respectively. In various implementations, EV 420 may comprise the same/similar vehicle as EV 102 from FIGS. 1A-1B, 2, and 3.

As depicted, EV 420 can execute operation 402 to join a first VMC 500. EV 420 may execute operation 402 in the same/similar manner as described in conjunction with FIGS. 1A-1B.

As depicted in FIG. 5A, in addition to EV 420, first VMC 500 may comprise a leader 504 and vehicles 506-1, 506-2, 506-3, and 506-4.

As described in conjunction with FIGS. 1A-1B, the vehicles of first VMC 500 may share resources (e.g., sensor resources, processing resources, memory resources, communication resources, etc.) to complete a task.

In various embodiments, leader 504 may detect that EV 420 has joined first VMC 500 as an EV. Accordingly, leader 504 may identify one or more sub-tasks of the task that can be performed at a later time. In other words, leader 504 can identify one or more sub-tasks that are deferrable for over a pre-determined amount of time. For example, the one or more (deferrable) sub-tasks may comprise post-processing sub-tasks such as refining an analytical model and uploading the refined analytical model to a remote server (e.g., remote server 356 from FIG. 3). Leader 504 may then assign the one or more (deferrable) sub-tasks to EV 420. Leader 504 may perform this assignment in the same/similar manner as described in conjunction with FIGS. 1A-1B.

EV 420 can then perform operation 404 to predict whether performance of the one or more sub-tasks it was assigned will deplete a state-of-charge for EV 420 over a threshold amount. In certain cases, this prediction may comprise predicting whether performance of the one or more sub-tasks will deplete the state-of-charge such that EV 420 will not reach a target destination without further charging. As described above, in certain implementations making this prediction may comprise using a look-up table that maps predicted energy consumption to VMC sub-tasks. In other implementations, making this prediction may comprise using a machine learning model trained to predict energy consumption for VMC sub-tasks.

If EV 420 predicts that performance of the one or more sub-tasks will not deplete its state-of-charge over the threshold amount, EV 420 can execute operation 406 to perform the one or more sub-tasks. In certain implementations, after performing the one or more sub-tasks, EV 420 can execute operation 414 to transmit a notification to leader 504 of first VMC 500. Such a notification may inform leader 504 that EV 420 has completed the one or more sub-tasks.

Before or after transmitting the notification of operation 414, EV 420 may receive data associated with the completed task of first VMC 500. As described in conjunction with FIGS. 1A-1B, such data may comprise an output of the completed task (e.g., recommendations for threat-mitigating actions such as changing a lane or altering a speed responsive to a detected threat).

If EV 420 predicts that performance of the one or more sub-tasks will deplete its state-of-charge over the threshold amount, EV 420 can execute operation 408 to withhold performance of the one or more sub-tasks. As described above, in some implementations this operation may comprise storing data related to the one or more sub-tasks (e.g., code blocks for performing the one or more sub-tasks) in memory.

After withholding performance of the one or more sub-tasks, EV 420 can execute operation 410 to become leader of a second VMC 510. As described above, in certain implementations this may comprise initiating formation of second VMC 510. EV 420 can execute this operation in the same/similar manner as described in conjunction with FIGS. 1A-1B.

As depicted in FIG. 5B, second VMC 510 may comprise EV 420 as leader, and vehicles 516-1, 516-2, 516-3, 516-4, 516-5, and 516-6 as additional members.

As depicted, in some cases second VMC 510 may comprise a completely different group of vehicles than first VMC 500 (besides EV 420). This may be the case, for example, when EV 420 traverses to a new region of a road segment such that EV 420 is surrounded by a different group of vehicles. In other cases however, second VMC 510 and first VMC 500 may have one or more vehicles in common (besides EV 420).

After becoming leader of second VMC 510, EV 420 can execute operation 412 to assign the one or more sub-tasks to one or more vehicles of second VMC 510. As described above, in various implementations this may comprise transferring the data related to the one or more sub-tasks to the one or more vehicles of second VMC 510. EV 420 can execute this operation in the same/similar manner as described in conjunction with FIGS. 1A-1B.

Before or after assigning the one or more sub-tasks to the one or more vehicles of second VMC 510, EV 420 may receive data associated with the completed task of first VMC 500. In certain implementations, EV 420 may transmit this data to the other vehicles of second VMC 510 as well. As described in conjunction with FIGS. 1A-1B, such data may comprise an output of first VMC 500's completed task (e.g., recommendations for threat-mitigating actions such as changing a lane or altering a speed responsive to a detected threat).

In certain implementations, after assigning the one or more sub-tasks to the one or more vehicles of second VMC 510, EV 420 can execute operation 414 to transmit a notification to leader 504 of first VMC 500. Such a notification may inform leader 504 that EV 420 has re-assigned the one or more sub-tasks. In other implementations, EV 420 may receive notification(s) from the one or more vehicles of second VMC 510 informing EV 420 that the one or more sub-tasks have been completed. Accordingly, EV 420 can execute operation 414 to transmit a notification to leader 504 of first VMC 500 informing leader 504 that the one or more sub-tasks have been completed. In other implementations, the one or more vehicles of second VMC 510 may communicate this information to leader 504 directly.

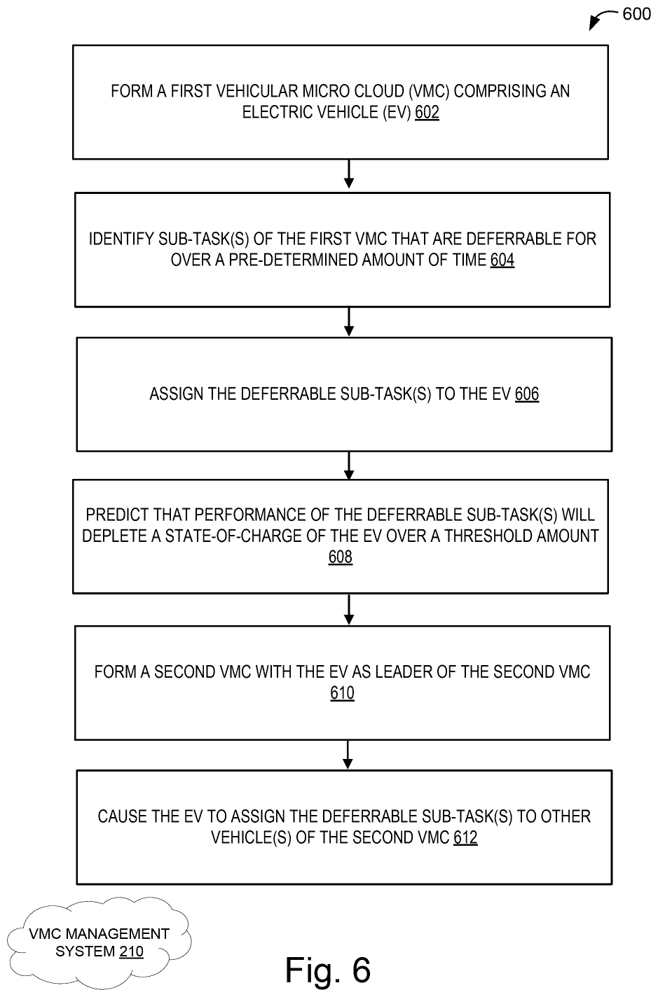

FIG. 6 illustrates an example process 600 that can be performed by a VMC management system to facilitate EV participation in VMCs, in accordance with various embodiments of the presently disclosed technology.

As depicted, in certain implementations VMC management system 210 from FIG. 3 may perform process 600.

For example, VMC management system 210 can execute operation 602 to form a first VMC comprising an EV. VMC management system 210 can execute this operation in the same/similar manner as described in conjunction with FIGS. 1A-1B.

VMC management system 210 can execute operation 604 to identify one or more sub-tasks of the first VMC that are deferrable for over a pre-determined amount of time. As described above, the one or more deferrable sub-tasks may be post-processing sub-tasks such as refining an analytical model and uploading the refined analytical model to a remote server.

VMC management system 210 can execute operation 606 to assign the one or more deferrable sub-tasks to the EV. VMC management system 210 can execute this operation in the same/similar manner as described in conjunction with FIGS. 1A-1B and 4.

VMC management system 210 can execute operation 608 to predict that performance of the one or more deferrable sub-tasks will deplete a state-of-charge of the EV over a threshold amount. VMC management system 210 can execute this operation in the same/similar manner as described in conjunction with FIGS. 1A-1B and 4.

VMC management system 210 can execute operation 610 to form a second VMC with the EV as leader of the second VMC. VMC management system 210 can execute this operation in the same/similar manner as described in conjunction with FIGS. 1A-1B and 4.

VMC management system 210 can execute operation 612 to cause the EV to assign the one or more deferrable sub-tasks to one or more other vehicles of the second VMC. VMC management system 210 can execute this operation in the same/similar manner as described in conjunction with FIGS. 1A-1B and 4.

In certain implementations, a respective deferrable sub-task may only be re-assigned below a threshold number of times. For example, if the threshold number of times is three and the respective deferrable sub-task has already been re-assigned once, VMC management system 210 may determine to only re-assign the respective deferrable sub-task to a non-EV vehicle the second time.

Relatedly, in some implementations, there may be a maximum pre-determined amount of time that a respective deferrable task can be deferred. Accordingly, in such implementations VMC management system 210 may determine to only re-assign the respective deferrable task to a non-EV vehicle when the amount of time the respective deferrable task has been deferred is within a threshold time interval from the maximum pre-determined amount of time.

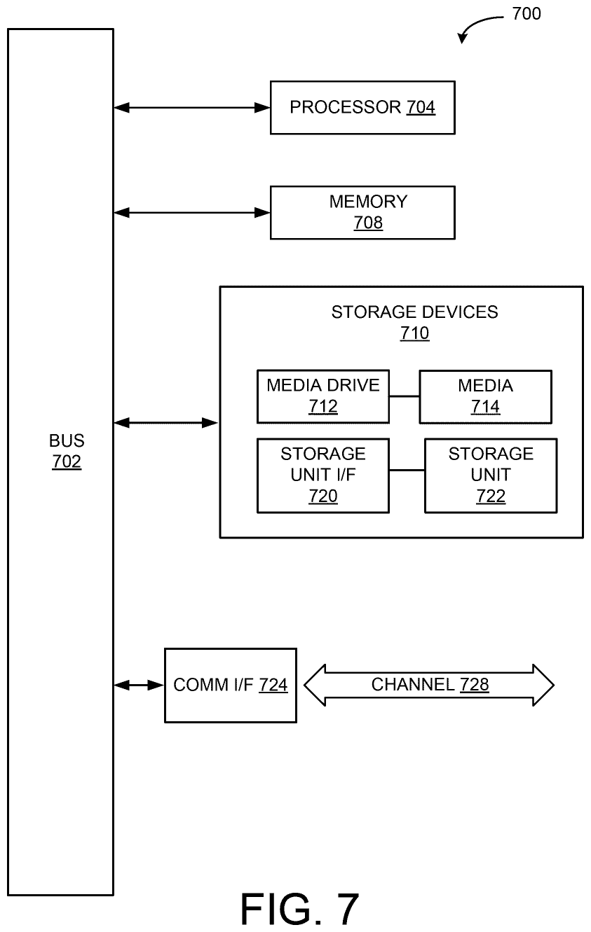

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. This can include a processor, and/or any one or more of the components making up a user device, a user system, and a non-decrypting cloud service. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communications interfaces. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known. ” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is target or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An electric vehicle (EV) comprising:
a battery that supplies electrical energy to an electric motor of the electric vehicle;
one or more processors; and
memory storing machine-readable instructions that, when executed by the one or more processors, cause the EV to:
join a first vehicular micro cloud (VMC) comprising a group of connected vehicles that share resources to complete a task;
predict performance of one or more sub-tasks assigned to the EV by the first VMC will deplete a state-of-charge of the battery over a threshold amount; and
based on the prediction indicating that the performance of the one or more sub-tasks will deplete the state-of-charge of the battery over the threshold amount:
withhold performance of the one or more sub-tasks,
become leader of a second VMC, and
as the leader of the second VMC, assign the one or more sub-tasks to one or more vehicles of the second VMC.

2. The EV of claim 1, wherein:
withholding performance of the one or more sub-tasks comprises storing data related to the one or more sub-tasks in the memory; and
assigning the one or more sub-tasks to one or more vehicles of the second VMC comprises transferring the data related to the one or more sub-tasks to the one or more vehicles of the second VMC.

3. The EV of claim 2, wherein the data related to the one or more sub-tasks comprises code blocks for performing the one or more sub-tasks.

4. The EV of claim 1, wherein the machine-readable instructions, when executed by the one or more processors, further cause the EV to:
after assigning the one or more sub-tasks to the one or more vehicle of the second VMC, transmit a notification to a leader of the first VMC.

5. The EV of claim 1, wherein the machine-readable instructions, when executed by the one or more processors, further cause the EV to:
initiate formation of the second VMC.

6. The EV of claim 1, wherein predicting that performance of the one or more sub-tasks will deplete the state-of-charge of the battery over the threshold amount comprises using a look-up table that maps predicted energy consumption to VMC sub-tasks.

7. The EV of claim 1, wherein predicting that performance of the one or more sub-tasks will deplete the state-of-charge of the battery over the threshold amount comprises using a machine learning model trained to predict energy consumption for VMC sub-tasks.

8. The EV of claim 1, wherein predicting that performance of the one or more sub-tasks will deplete the state-of-charge of the battery over the threshold amount comprises:
predicting that performance of the one or more sub-tasks will deplete the state-of-charge of the battery such that the EV will not reach a target destination without further charging the battery.

9. The EV of claim 1, wherein the one or more sub-tasks comprise post-processing sub-tasks.

10. The EV of claim 9, wherein the post-processing sub-tasks comprise refining an analytical model and uploading the refined analytical model to a remote server.

11. The EV of claim 1, wherein:
the second VMC comprises a second group of connected vehicles; and
other than the EV, the second group of connected vehicles comprises different vehicles than the group of connected vehicles.

12. A method comprising:
joining, by an electric vehicle (EV), a first vehicular micro cloud (VMC) comprising a first group of connected vehicles that share resources to complete a task;
predicting, by the EV, that performance of one or more sub-tasks assigned to the EV by the first VMC will deplete a state-of-charge of the EV over a threshold amount; and
based on the prediction indicating that the performance of the one or more sub-tasks will deplete the state-of-charge of the EV over the threshold amount: withholding, by the EV, performance of the one or more sub-tasks based on the prediction;
becoming, by the EV, leader of a second VMC; and
assigning, by the EV as the leader of the second VMC, the one or more sub-tasks to one or more vehicles of the second VMC.

13. The method of claim 12, wherein:
withholding performance of the one or more sub-tasks comprises storing data related to the one or more sub-tasks in memory; and
assigning the one or more sub-tasks to one or more vehicles of the second VMC comprises transferring the data related to the one or more sub-tasks to the one or more vehicles of the second VMC.

14. The method of claim 13, wherein the data related to the one or more sub-tasks comprises code blocks for performing the one or more sub-tasks.

15. The method of claim 12, further comprising, after assigning the one or more sub-tasks to the one or more vehicle of the second VMC, transmitting a notification to a leader of the first VMC.

16. The method of claim 12, further comprising initiating formation of the second VMC.

17. The method of claim 12, wherein predicting that performance of the one or more sub-tasks will deplete the state-of-charge of the EV over the threshold amount comprises at least one of:
using a look-up table that maps predicted energy consumption to VMC sub-tasks; and
using a machine learning model trained to predict energy consumption for VMC sub-tasks.

18. The method of claim 12, wherein the one or more sub-tasks comprise post-processing sub-tasks.

19. The method of claim 18, wherein the post-processing sub-tasks comprise refining an analytical model and uploading the refined analytical model to a remote server.

20. A method comprising:
forming a first vehicular micro cloud (VMC) comprising an electric vehicle (EV);
identifying one or more sub-tasks of the first VMC that are deferrable for greater than a pre-determined amount of time;
assigning the one or more deferrable sub-tasks to the EV; and
responsive to predicting that performance of the one or more deferrable sub-tasks by the EV will deplete a state-of-charge of the EV over a threshold amount:
forming a second VMC with the EV as leader of the second VMC; and
causing the EV to assign the one or more deferrable sub-tasks to one or more other vehicles of the second VMC.
